(19) United States
(12) Patent Application Publication
(10) Pub. No.: US 2025/0251377 A1
(43) Pub. Date: Aug. 7, 2025

(54) DISINFECTANT VISUALIZING SHEET

(71) Applicant: CANON KABUSHIKI KAISHA, Tokyo (JP)

(72) Inventors: MASANORI SEKI, Kanagawa (JP); HIROSHI SAITO, Kanagawa (JP); KOROMO SHIROTA, Kanagawa (JP); MASARU SUGITA, Tokyo (JP)

(21) Appl. No.: 19/188,958

(22) Filed: Apr. 24, 2025

Related U.S. Application Data
(63) Continuation of application No. PCT/JP2023/036467, filed on Oct. 6, 2023.

(30) Foreign Application Priority Data
Oct. 26, 2022 (JP) 2022-171843

(51) Int. Cl. G01N 31/22; G01N 21/78

(52) U.S. Cl. CPC G01N 31/226; G01N 21/78

(57) ABSTRACT

A disinfectant visualizing sheet includes a base material, a chromogenic portion disposed on the base material, and a coating portion on the chromogenic portion, wherein the chromogenic portion includes a visualizing agent that changes a color state thereof upon exposure to a disinfectant, and wherein the coating portion has a silsesquioxane structure.

### CROSS-REFERENCE TO RELATED APPLICATIONS

This application is a Continuation of International Patent Application No. PCT/JP2023/036467, filed Oct. 6, 2023, which claims the benefit of J apanese Patent Application No. 2022-171843, filed Oct. 26, 2022, both of which are hereby incorporated by reference herein in their entirety.

### BACKGROUND OF THE INVENTION

### Field of the Invention

The present invention relates to a disinfectant visualizing sheet.

### Background Art

In recent years, the risk of infectious diseases has been increasing, and city lockdowns have also been implemented in consideration of healthcare systems. In daily life, there are more cases where face-to-face interactions are not possible. In highly public spaces, such as coworking spaces, occupancy rates have decreased, the productivity of users of these facilities has declined, and business opportunities have been lost. This, in turn, raises concerns about economic decline.

Thus, the act of cleaning and disinfection is emphasized, and a technique for visualizing this act is discussed. In PTL 1, the disinfection operation in cleaning is visualized using fluorescent materials in the ultraviolet range. However, this technique requires special tools, making it less convenient.

For example, PTL 2 discusses a technique in which the color of a pH-responsive dye changes through its reaction with a disinfectant. However, this method involves mixing two reactive substances into a single solution, making long-term storage difficult. Additionally, PTL 3 discusses a technique that includes a detection species in an aerogel to induce color change, this technology lacks durability for repeated use.

Further, PTLs 1 and 2 discuss materials capable of visualizing disinfectant applications but do not discuss how to record and manage disinfectant application statuses in a case where there are a large number of disinfection targets. In a case where there are a large number of disinfection targets, manually recording disinfectant applications by individuals or inputting disinfectant application records into a computer is time-consuming and may lead to inaccurate recording of application statuses.

### CITATION LIST

### Patent Literature

PTL 1: U.S. Pat. No. 8,519,360
PTL 2: United States Patent Application Publication No. 2017/0336373
PTL 3: Japanese Patent Application Laid-Open No. 2020-101535

### SUMMARY OF THE INVENTION

Thus, the present invention is directed to providing a disinfectant visualizing sheet and disinfectant visualizing particles that can be stored for a long time, can allow convenient visual confirmation of an application of a disinfectant, and can be used repeatedly.

Further, the present invention is also directed to providing an information acquisition system capable of accurately and conveniently acquiring information about disinfectant applications.

According to an aspect of the present invention, a disinfectant visualizing sheet includes a base material, a chromogenic portion disposed on the base material, and a coating portion on the chromogenic portion, wherein the chromogenic portion includes a visualizing agent that changes a color state thereof upon exposure to a disinfectant, and wherein the coating portion has a silsesquioxane structure.

According to another aspect of the present invention, a disinfectant visualizing sheet includes a base material, a chromogenic portion disposed on the base material, and a coating portion on the chromogenic portion, wherein the chromogenic portion includes a visualizing agent that changes a color state thereof upon exposure to a disinfectant, and wherein the coating portion includes polyethyleneimine.

Further features of the present invention will become apparent from the following description of exemplary embodiments with reference to the attached drawings.

### BRIEF DESCRIPTION OF THE DRAWINGS

FIG. 1 is a schematic diagram illustrating a disinfectant visualizing sheet according to a first embodiment of the present invention.

FIG. 2 is a schematic diagram illustrating an example of the disinfectant visualizing sheet according to the first embodiment of the present invention.

FIG. 3 is a schematic diagram illustrating a disinfectant visualizing particle according to a second embodiment of the present invention.

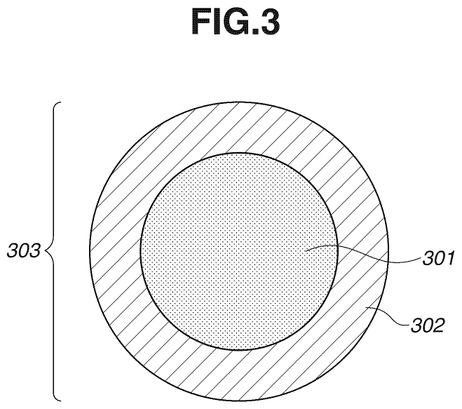

FIG. 4 is a schematic diagram illustrating an example of a disinfectant visualizing sheet according to the second embodiment of the present invention.

### DESCRIPTION OF THE EMBODIMENTS

While embodiments of the present invention will be described below, the present invention is not limited to those described below.

In the embodiments, a surface to be disinfected may be any surface of furniture, such as a desk, a table, or a chair, a floor, or a wall, whether horizontal or vertical. A surface to be disinfected may be a wooden, plastic, or metal surface, and a sheet is attached to the surface, or the surface is coated with particles.

In the embodiments, disinfectant and a visualizing agent are separately disposed and react with each other when used. The visualizing agent is disposed on a surface to be disinfected, and the disinfectant is brought into contact with the surface to cause a change in color state (appearance). This change in appearance is visually detectable.

A disinfectant visualizing sheet according to an embodiment includes a base material, a chromogenic portion disposed on the base material, and a coating portion on the chromogenic portion. The chromogenic portion includes a visualizing agent that changes its color state upon exposure to a disinfectant. The coating portion includes a silsesquioxane structure. Here, the coating portion desirably has a thickness of 10 nm or more and 300 nm or less. Further, the coating portion desirably has the silsesquioxane structure containing at least one type of functional group selected from the group consisting of vinyl group, epoxy group, amino group, styryl group, methacrylic group, acrylic group, isocyanurate group, ureido group, mercapto group, and isocyanate group.

A disinfectant visualizing sheet according to another embodiment includes a base material, a chromogenic portion disposed on the base material, and a coating portion on the chromogenic portion. The chromogenic portion includes a visualizing agent that changes its color state upon exposure to a disinfectant. The coating portion includes polyethyleneimine.

Examples of disinfectant visualizing sheets and disinfectant visualizing particles will be described below.

### First Embodiment: Disinfectant Visualizing Sheet

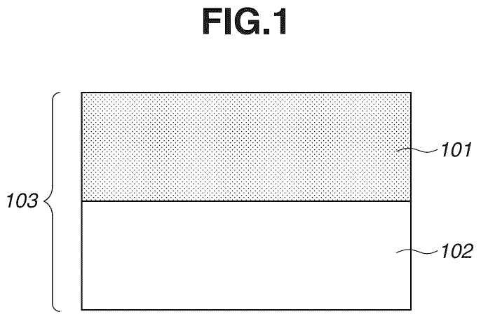

A disinfectant visualizing sheet 103 according to a first embodiment includes a base material 102 and a chromogenic portion 101 disposed on the base material 102 (FIG. 1). The chromogenic portion 101 includes a visualizing agent (not illustrated) that change its color state upon exposure to a disinfectant. Thus, the use of the disinfectant visualizing sheet 103 according to the present embodiment enables easy confirmation of the application of the disinfectant through a visual observation of a change in the color state, which is convenient. Further, the disinfectant and the visualizing agent are mixed when the disinfectant is applied to the disinfectant visualizing sheet 103, so that the duration for which the disinfectant and the visualizing agent are mixed is short. This facilitates the long-term storage of the materials used. Here, the application of the disinfectant means that the disinfectant reaches the visualizing agent, and examples include spraying the disinfectant and wiping with a duster containing the disinfectant.

### <Chromogenic Portion>

The chromogenic portion according to the present embodiment includes at least a visualizing agent. The chromogenic portion may include a binder to improve adhesion to the base material 102. Resin may be used as a binder. For example, urethane resin or polyvinyl alcohol can be used.

The chromogenic portion according to the present embodiment desirably has a thickness of 1 μm or more and 80 μm or less, more desirably 5 μm or more and 60 μm or less, even more desirably 15 μm or more and 50 μm or less. With the chromogenic portion having a thickness of 80 μm or less, the adhesion to the base material 102 is improved, and with the chromogenic portion having a thickness of 1 μm or more, the color state of the chromogenic portion is improved.

It is sufficient to provide the chromogenic portion according to the present embodiment on at least a portion of the base material 102, or the chromogenic portion according to the present embodiment may be disposed on the entire surface of the base material 102. Example patterns of the chromogenic portion arrangement on at least a portion of the base material 102 include a dotted pattern and a checkerboard pattern. Further, the starting and ending positions of the wiping with the disinfectant may be indicated based on the formation pattern of the chromogenic portion. Further, in the case of providing the chromogenic portion on the base material 102 in the shape of a rectangle, a formation pattern in which the chromogenic portion formed near the central portion is smaller in area than those at the four corners may be employed.

The visualizing agent according to the present embodiment is not particularly limited and may be any visualizing agents that changes its color state upon reacting with the disinfectant described below. In the present embodiment, a change in the color state refers to a change that results in a visually noticeable color difference before and after the application of the disinfectant. Examples include a change from a visually invisible state to a visually visible state, a change from a visually visible state to a visually invisible state, and a visually noticeable color change.

Here, the visually noticeable color change includes a change in color shades and a change in color. For example, the change in color shades refers to a change from dark red to light red, and the change in color refers to a change from red to blue. Further, examples of a visually noticeable color change include a change from colorless to colored and vice versa.

The visualizing agent may be made of a combination of a plurality of materials that exhibit different color state changes from each other.

An example of a phenomenon in which a color state changes is chromism. Examples of chromism include photochromism, thermochromism, electrochromism, acidichromism, solvatochromism, and vapochromism. In the present embodiment, substances that exhibit these phenomena are referred to as chromic substances, particularly a photochromic substance, a thermochromic substance, an electrochromic substance, an acidichromic substance, a solvatochromic substance, and a vapochromic substance.

The acidichromic substance changes color in response to changes in pH, and the color range varies depending on the properties of each substance. Examples include at least one type selected from the group consisting of Metanil Yellow, Metacresol Purple, Thymol Blue, Tropaeolin O, 2,4-Dinitrophenol, Methyl Yellow, Bromophenol Blue, Congo Red, Methyl Orange, Bromochlorophenol Blue, Alizarin Red S, Bromocresol Green, Methyl Orange-Xylene Cyanol FF, 2,5-Dinitrophenol, Methyl Orange-Indigo Carmine, Methyl Red, Methyl Orange-Xylene Cyanol FF-Phenolphthalein, Lacmoid, Chlorophenol Red, o-Nitrophenol, p-Nitrophenol, Bromocresol Green-Methyl Red, Bromocresol Purple, Bromophenol Red, Methyl Red-Methylene Blue, Bromothymol Blue, Neutral Red, Phenol Red, Neutral Red-Bromothymol Blue, Cresol Red, α-Naphtholphthalein, Bromothymol Blue-Phenol Red, Curcumin, Phenolphthalein, Cresol Red-Thymol Blue, o-Cresolphthalein, α-Naphtholbenzein, Thymolphthalein, Thymol Blue-Phenolphthalein, Alizarin Yellow GG, Alizarin Yellow R, Tropaeolin O, Nitramine, 1,3,5-Trinitrobenzene, Indigo Carmine, Methyl Violet, Litmus, and Methyl Purple. From the perspective of low toxicity, Metanil Yellow, Metacresol Purple, Thymol Blue, Tropaeolin O, Bromophenol Blue, Bromochlorophenol Blue, Alizarin Red S, Bromocresol Green, Methyl Red, Lacmoid, Chlorophenol Red, o-Nitrophenol, Bromocresol Purple, Bromophenol Red, Bromothymol Blue, Neutral Red, Phenol Red, Cresol Red, α-Naphtholphthalein, Phenolphthalein, o-Cresolphthalein, Thymolphthalein, Alizarin Yellow GG, Alizarin Yellow R, Tropaeolin O, Methyl Violet, Litmus, and Methyl Purple are desirable. Metacresol Purple, Thymol Blue, Tropaeolin O, Bromophenol Blue, Bromochlorophenol Blue, Alizarin Red S, Bromocresol Green, Methyl Red, Lacmoid, Chlorophenol Red, o-Nitrophenol, Bromocresol Purple, Bromophenol Red, Bromothymol Blue, Neutral Red, Phenol Red, Cresol Red, α-Naphtholphthalein, Phenolphthalein, o-Cresolphthalein, Thymolphthalein, Alizarin Yellow GG, Alizarin Yellow R, Litmus, and Methyl Purple are more desirable because they change color at a pH of 3 or above and 11 or below. A substance that changes color in the alkaline pH range is at least one type selected from the group consisting of p-Nitrophenol, Bromothymol Blue, Neutral Red, Phenol Red, Cresol Red, Phenolphthalein, Cresolphthalein, Thymolphthalein, Alizarin Yellow, Tropaeolin, and Indigo Carmine. In a case where an alkaline disinfectant is used, it is desirable for the color to change in the alkaline range, while in a case where an acidic disinfectant is used, it is desirable for the color to change in the acidic range.

Two or more types of visualizing agents may be used. For example, it is desirable to use visualizing agents with different durations of color retention because this enables the elapsed time since contact with the disinfectant to be displayed as an indicator.

Further, the visualizing agent may be disposed to present text information, image information (diagram), or both image information and text information. While text information and image information are not particularly limited, if the information that has appeared are designed to be appealing to users of a disinfected area, this can presumably encourage the users to apply the disinfectant voluntarily. Further, the visualizing agent changes color as the disinfectant evaporate, and the visualizing agent recovers. H ere, the term “recover” refers to returning to the state before the application of the disinfectant. In other words, the color state is reversible. That is to say, in the present embodiment, the visualizing agent can be used that changes its color state for a predetermined time upon the application of the disinfectant and thereafter returns to the state before the application of the disinfectant. For example, the visualizing agent in a visually invisible state may undergo a color change to a visually visible state upon the application of the disinfectant and return to the visually invisible state after a predetermined time. Being reversible as described above, the visualizing agent can be used in situations where repeated disinfection is demanded.

### <Base Material>

The base material 102 in the present embodiment may be any base materials on which the chromogenic portion can be disposed.

The base material 102 that is a resin sheet is desirable because it is lightweight and flexible. Examples of resin sheets include polyester resins, such as polyethylene terephthalate, polybutylene terephthalate, and polyethylene terephthalate/isophthalate copolymers, polyolefin resins, such as polyethylene, polypropylene, and polymethylpentene, polyfluoroethylene-based resins, such as polyvinyl fluoride, polyvinylidene fluoride, polytetrafluoroethylene, and ethylene-tetrafluoroethylene copolymers, aliphatic polyamide resins, such as Nylon 6 and Nylon 6,6, vinyl polymer resins, such as polyvinyl chloride, vinyl chloride/vinyl acetate copolymers, ethylene/vinyl acetate copolymers, ethylene/vinyl alcohol copolymers, polyvinyl alcohol, and vinylon, cellulose-based resins, such as cellulose triacetate and cellophane, acrylic resins, such as polymethyl methacrylate, polyethyl methacrylate, polyethyl acrylate, and polybutyl acrylate, and other synthetic resins, such as polystyrene, polycarbonate, polyarylate, and polyimide. A single type of resin sheet may be used singly, or two or more types may be combined or layered for use. The base material 102 is desirably disposed with a receiving layer configured to retain the chromogenic portion. This is because the receiving layer can easily retain the visualizing agent in a case where the visualizing agent is ink.

The receiving layer of the base material 102 in the present embodiment desirably does not react with the visualizing agent. For example, in a case where the visualizing agent develops color in an alkaline condition, the receiving layer is desirably neutral or acidic. If the receiving layer reacts with the visualizing agent, the visualizing agent may change the color state before reacting with the disinfectant, which is undesirable.

The base material 102 in the present embodiment may be transparent, opaque, or colored. In a case where the visualizing agent has color before reacting with the disinfectant, it is desirable that the base material 102 has color that matches or close to the color of the visualizing agent.

Release paper, metal sheet, and wood can be used as the base material 102 in the present embodiment. Further, a bonding portion may be disposed to bond the base material 102 to another member. The bonding portion may be disposed on the entire surface or only on part of the base material 102. A configuration in which bonding portion is partially disposed facilitates easy removal. Further, the bonding portion can include ultraviolet (UV) curable resin to facilitate easy removal.

Further, in a case where the base material 102 is paper, an anionic, cationic, or nonionic surfactant may be included in the chromogenic portion to improve the compatibility of the visualizing agent with the paper. It is desirable to use a nonionic surfactant, such as polyoxyethylene alkyl ether, polyoxyethylene fatty acid ester, polyoxyethylene alkylphenyl ether, polyoxyethylene-polyoxypropylene block copolymer, or an acetylene glycol based compound.

### <Coating Portion>

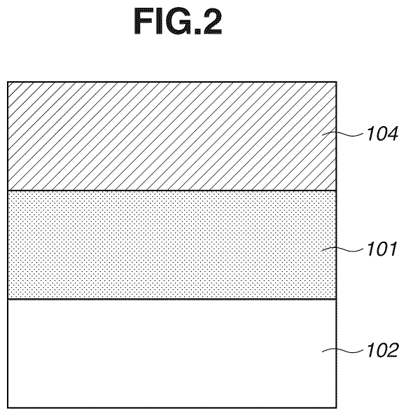

The disinfectant visualizing sheet 103 in the present embodiment may include a coating portion 104 (FIG. 2) that retains the disinfectant on the chromogenic portion 101 and enables repeated use.

In the present embodiment, it is sufficient for the coating portion 104 disposed on the chromogenic portion to allow sufficient disinfectant to pass through to the extent that the visualizing agent develops color, and to have durability to withstand repeated wiping with the disinfectant. In a case where a neutral disinfectant and a visualizing agent with a color-reaction range on the alkaline side are used in combination, it is desirable for the coating portion 104 to be made of an alkaline material.

Examples of coating portions include resins, such as acrylic resin, polyvinyl chloride resin, polyamide resin, polyester resin, urethane resin, and polyethyleneimine, and organic-inorganic hybrid materials, such as polyphosphazene and silsesquioxane. Among the examples, silsesquioxane is desirable. Silsesquioxane (hereinafter, sometimes abbreviated as “SQ”) refers to a siloxane-based compound with a backbone structure consisting of Si—O bonds, represented by the molecular formula [R1(SiO1.5)n]. R1 is desirably at least one substituent group selected from the group consisting of vinyl group, epoxy group, amino group, styryl group, methacrylic group, acrylic group, isocyanurate group, an ureido group, a mercapto group, and an isocyanate group. In a case where silsesquioxane plays a role in bonding particles composed of numerous solid substances, superior film strength can be achieved while high porosity is maintained. The form of the silsesquioxane as a polymer is not particularly limited, and examples include known linear polysiloxane, cage-type polysiloxane, and ladder-type polysiloxane. The silsesquioxane structure refers to a structure in which each silicon atom is bonded to three oxygen atoms and each oxygen atom is bonded to two silicon atoms (the number of oxygen atoms relative to the number of silicon atoms is 1.5). From a cost perspective, linear polysiloxane, cage-type polysiloxane, and ladder-type polysiloxane may be mixed.

Examples of a silane coupling agent as raw materials for silsesquioxane include vinyltrimethoxysilane, vinyltriethoxysilane, 2-(3,4-epoxycyclohexyl)ethyltrimethoxysilane, 3-glycidoxypropylmethyl dimethoxysilane, 3-glycidoxypropyltrimethoxysilane, 3-glycidoxypropylmethyl diethoxysilane, 3-glycidoxypropyltriethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, tris-(trimethoxysilylpropyl)isocyanurate, 3-ureidopropyltrialkoxysilane, 3-mercaptopropylmethyldimethoxysilane, 3-mercaptopropyltrimethoxysilane, 3-isocyanatopropyltriethoxysilane, and 3-trimethoxysilylpropylsuccinic anhydride.

One or more types selected from the foregoing examples may be used.

The above-mentioned silane coupling agents may be dissolved in a solvent to prepare a coating solution. An organic solvent is desirable as a solvent. The organic solvent is not particularly limited, and alcohols, carboxylic acids, aliphatic or alicyclic hydrocarbons, aromatic hydrocarbons, esters, ketones, ethers, or a mixed solvent containing two or more types of these can be used. For example, methanol, ethanol, 2-propanol, butanol, 2-methoxyethanol, 2-ethoxyethanol, 1-methoxy-2-propanol, 1-ethoxy-2-propanol, 1-propoxy-2-propanol, 4-methyl-2-pentanol, 2-ethylbutanol, 3-methoxy-3-methylbutanol, ethylene glycol, diethylene glycol, and glycerin are desirable alcohols. It is particularly desirable to use n-butyric acid, α-methylbutyric acid, iso-valeric acid, 2-ethylbutyric acid, 2,2-dimethylbutyric acid, 3,3-dimethylbutyric acid, 2,3-dimethylbutyric acid, 3-methylpentanoic acid, 4-methylpentanoic acid, 2-ethylpentanoic acid, 3-ethylpentanoic acid, 2,2-dimethylpentanoic acid, 3,3-dimethylpentanoic acid, 2,3-dimethylpentanoic acid, 2-ethylhexanoic acid, or 3-ethylhexanoic acid as the carboxylic acid. As aliphatic or alicyclic hydrocarbons, n-hexane, n-octane, cyclohexane, cyclopentane, and cyclooctane are particularly desirable. As aromatic hydrocarbons, toluene, xylene, and ethylbenzene are desirable. As esters, ethyl formate, ethyl acetate, n-butyl acetate, ethylene glycol monomethyl ether acetate, ethylene glycol monoethyl ether acetate, ethylene glycol monobutyl ether acetate, and γ-butyrolactone are desirable. As ketones, acetone, methyl ethyl ketone, methyl isobutyl ketone, and cyclohexanone are desirable. As ethers, dimethoxyethane, tetrahydrofuran, dioxane, and diisopropyl ether are desirable.

In preparing a coating solution, it is desirable to use alcohols, among the various types of solvents described above, from the perspective of the stability of the solution.

A predetermined amount of a silane coupling agent may be added into an organic solvent, thus preparing the coating solution.

In forming a layer using the coating solution, it is desirable to perform the application in an inert gas atmosphere such as dry air or dry nitrogen. It is desirable to set the relative humidity of the dry atmosphere to 30% or less.

Further, as a solution coating method for forming a layer, a known coating method can be employed, such as a dipping method, a spin coating method, a spraying method, a printing method, a flow coating method, or a combination thereof. The layer thickness can be controlled by changing a lifting speed in the dipping method or a substrate rotation speed in the spin coating method, and changing the concentration of the coating solution.

The coating portion in the present embodiment desirably has a thickness of 10 nm or more and 1 μm or less, more desirably 10 nm or more and 500 nm or less, even more desirably 10 nm or more and 300 nm or less. With the coating portion having a thickness of 1 μm or less, a favorable balance is achieved between the color state of the chromogenic portion and durability.

### <Disinfectant>

The disinfectant in the present embodiment is used for sanitization, sterilization, and disinfection and may be any liquid compositions that reacts with the visualizing agent to change its color state. Examples of active ingredients include surfactants, basic components, acidic components, and alcohols. Further, examples of basic components include alkalis, perchloric acid, hypochlorous acid, and sodium salts thereof. The reaction between the disinfectant and the visualizing agent in the present embodiment may occur in a liquid medium or at a solid-liquid interface, and it may occur under ambient temperature and pressure conditions, as well as under conditions of heating, cooling, or pressure application. As principles, examples include photochromism, thermochromism, electrochromism, acidichromism, solvatochromism, and vapochromism described above. Further, the reaction may be irreversible or reversible. The disinfectant in the present embodiment may be made of a weakly acidic material. Examples of weakly acidic materials include organic acids, such as citric acid, malic acid, lactic acid, or succinic acid, and weakly acidic hypochlorous acid water.

### <Another Example of Disinfectant Visualizing Sheet>

In another example of the disinfectant visualizing sheet 103 in the present embodiment, the chromogenic portion may be disposed with visualizing particles including a visualizing agent and carrier particles carrying the visualizing agent. An aggregate of visualizing particles may be configured to function as a chromogenic portion. The use of the visualizing particles allows microscopic design of the positions of a moisturizing layer and a layer including the visualizing particles, thus enabling precise characteristics design.

### <Non-Visible Portion>

In yet another example of the disinfectant visualizing sheet 103 in the present embodiment, a plurality of principles can be used in combination in addition to the visualizing agent described above. The sheet including the chromogenic portion may be provided with a non-visible portion. In the non-visible portion in the present embodiment, non-visible material that absorbs light in the ultraviolet and infrared wavelength ranges may be incorporated. The ultraviolet and infrared ranges include the near-ultraviolet and near-infrared ranges. By providing the non-visible material, additional confirmation from a third-party perspective becomes possible in addition to visual confirmation of the disinfectant application.

Further, thermochromism can also be used in combination for the disinfectant visualizing sheet 103 in the present embodiment. For example, the chromogenic portion is used together with a dye that changes color in response to temperature. As a result, in addition to a color change caused by the presence or absence of the disinfectant, a color change also occurs in response to a change in temperature from the usage environment. As a result, the history of actions, such as finger touches, can be indirectly identified. The thermochromism dye can be selected from known substances.

As a dye that absorbs light in the infrared wavelength range, among the non-visible materials in the present embodiment, at least one type selected from the group consisting of a phthalocyanine-based dye, a naphthalocyanine-based dye, a metal complex dye, a polymethine-based dye, a quinone-based dye, an azo-based dye, diphenylmethane and triphenylmethane-based dyes, a radical-based dye, a perimidine-based dye, and Au nanorod can be used. As a dye that absorbs light in the ultraviolet range and emits fluorescence, at least one type selected from the group consisting of merocyanine, perylene, acridine, luciferin, pyranine, stilbene, rhodamine, coumarin, and fluorescein can be used.

### <Visually Detectable Wavelength Ranges, Infrared and Ultraviolet Wavelength Ranges>

The visible light wavelength range in the present embodiment refers to a range of light wavelengths from 360 nm to 830 nm, inclusive. Further, in the present embodiment, the infrared wavelength range refers to a range of light wavelengths from 900 nm to 14 μm, inclusive, and the ultraviolet wavelength range refers to a range of light wavelengths from 100 nm to 400 nm, inclusive.

### <Marking Composition>

The chromogenic portion that is included in the disinfectant visualizing sheet 103 in the present embodiment may be served as a marking to indicate whether the disinfectant has been applied (cleaned). A material for marking in the present embodiment can be referred to as a marking composition. The marking composition contains the visualizing agent and a solvent, and examples of solvents include hydrophobic solvents and aqueous solvents. Examples of hydrophobic solvents include organic solvents, such as heptane and petroleum ether, and examples of aqueous solvents include water and alcohols.

Further, in a case where the visualizing agent is poorly soluble in water, a dispersing agent for dispersing the visualizing agent in water is included. Any conventionally known dispersing agent can be used.

In a case where the visualization agent changes color due to acidichromism, the dispersing agent particularly desirably includes one or more types of functional groups selected from the group consisting of polyethylene oxide group, polypropylene oxide group, and polyglycerin group. This suggests that acidichromism requires water as a mediator, and the presence of these functional groups near the visualization agent makes it easier for water to be drawn in, thereby facilitating the color change. Further, the water-retaining effect of these functional groups facilitates the persistence of color development. In particular, in a case where the visualizing agent is Thymol Blue or Ortho-Cresol Phthalein Thymol Blue or Ortho-Cresol Phthalein developing color due to acidichromism, a dispersing agent containing one or more types of functional groups selected from polyethylene oxide, polypropylene oxide, and polyglycerin groups is desirable for the above-described reason.

In contrast, in a case where a highly hydrophobic dispersing agent, such as a styrene-maleic acid copolymer with a molecular weight of 10,000 or higher, is used, the dispersing agent may cover the visualizing agent in the chromogenic portion, which may inhibit the color change caused by the disinfectant.

As the a dispersing agent containing one or more types of functional groups selected from polyethylene oxide, polypropylene oxide, and polyglycerin groups, an EO-PO block polymer-based dispersing agent primarily composed of an ethylene oxide (EO) and propylene oxide (PO) copolymer (product name: Disper BYK 183, Disper BYK 185, or Disper BYK 190 manufactured by BYK-Chemie GmbH), a decaglycerin-based dispersing agent (product name: NICCOL decaglycerin 1-ISV manufactured by Nikko Chemicals Co., Ltd.), and an ethylene oxide-based dispersing agent (product name: EMULGEN 420 manufactured by Kao Corporation) are desirable. Among them, the EO-PO block polymer-based dispersing agent is desirable.

These dispersing agents are used in an amount of 30% to 200% relative to the total mass of the visualizing agent and are dispersed using a conventional known method to form ink components.

In the present embodiment, an aqueous solvent can be used, which may be water or a mixed medium that uses water as the main solvent in combination with a protic organic solvent or an aprotic organic solvent. As the organic solvent in the present embodiment, it is desirable to use one that is miscible or soluble with water in any proportion, and it is desirable to use a homogeneous mixed medium containing 50% or more by mass of water. As for the water, it is desirable to use deionized water (ion-exchanged water) or ultrapure water.

Protonic organic solvents are organic solvents containing hydrogen atoms bounded to oxygen or nitrogen (acidic hydrogen atoms). Further, aprotic organic solvents are organic solvents containing no acidic hydrogen atoms. Examples of organic solvents include alcohols, alkylene glycols, polyalkylene glycols, glycol ethers, glycol ether esters, carboxylic acid amides, ketones, keto alcohols, and cyclic ethers.

Examples of aqueous media that are desirably used include water, water-ethanol mixed solvent, water-ethylene glycol mixed solvent, and water-N-methylpyrrolidone mixed solvent. The water content is desirably 10.0% by mass or more and 90.0% by mass or less, more desirably 50.0% by mass or more and 90.0% by mass or less, based on the total mass of the composition.

The water-soluble organic solvent content in the composition is desirably 5.0% by mass or more and 90.0% by mass or less, more desirably 10.0% by mass or more and 50.0% by mass or less, based on the total mass of the composition.

### (Other Additives)

The marking composition in the present embodiment may further include a water-soluble organic compound such as polyhydric alcohols, such as trimethylolpropane or trimethylolethane, urea, or an urea derivative, such as ethylene urea, as necessary, in addition to the above-described components. Further, the marking composition in the present embodiment may contain various additives, such as a surfactant, a pH adjuster, a rust inhibitor, a preservative, an anti-mold agent, an antioxidant, a reduction inhibitor, an evaporation promoter, a chelating agent, and a water-soluble resin, as necessary. Examples of surfactants include anionic, cationic, and nonionic surfactants. The surfactant content in the marking composition is desirably 0.1% by mass or more and 5.0% by mass or less, more desirably 0.1% by mass or more and 2.0% by mass or less, based on the total mass of the composition. Specific examples of surfactants that are desirably used include nonionic surfactants, such as polyoxyethylene alkyl ether, polyoxyethylene fatty acid ester, polyoxyethylene alkylphenyl ether, a polyoxyethylene-polyoxypropylene block copolymer, and an acetylene glycol based compound.

In the case of recording an image on a recording medium by ejecting the marking composition in the present embodiment from an inkjet recording head, it is desirable to use a marking composition with appropriately controlled surface tension and viscosity. Specifically, the concentration of color-forming compounds in the marking composition is desirably about 5% to about 20%. The surface tension of the composition at 25° C. is desirably 10 mN/m or more and 60 mN//m or less, more desirably 20 mN//m or more and 60 mN//m or less, even more desirably 30 mN//m or more and 50 mN//m or less.

Further, the viscosity of the composition at 25° C. is desirably 1.0 mPa-s or more and 10 mPa-s or less, more desirably 1.0 mPa-s or more and 5 mPa-s or less.

### <Image Recording Method (Marking Composition Application Method)>

An image recording method in the present embodiment relates to a method for applying the marking composition to the base material 102. Various methods are applicable to the image recording method in the present embodiment, and examples include an inkjet method, a flexographic method, a screen method, an offset method, and a spin coating method. For example, the inkjet method is a method for recording an image on a recording medium by ejecting the marking composition in the present embodiment from an inkjet recording head. Examples of methods for ejecting the marking composition include a method in which mechanical energy is applied to the marking composition and a method in which thermal energy is applied to the composition. Except for the use of the marking composition in the present embodiment, a known method can be used in the process of the inkjet recording method.

In addition to the image recording method described above, an electrophotographic method can be used as an image recording method.

### <Toner Manufacturing Method>

Toner manufacturing methods in the electrophotographic method in the present embodiment are not particularly limited, and examples include the following toner manufacturing methods (1) to (3).

### (1) Grinding Method

In manufacturing toner using a grinding method, initially, the visualizing agent is thoroughly mixed with binder resin serving as a dispersing medium and other additives using a mixing device, such as a Henschel mixer or a ball mill. Using a thermal kneading machine, such as a kneader or extruder, which applies heat and mechanical shear force, the mixture is melt-kneaded to make the resins compatible with each other. After cooling and solidifying the melt-kneaded material, the solidified material is pulverized, and the pulverized material is classified to obtain toner particles of the desired particle diameter (size).

### (2) Suspension Polymerization Method

In a suspension polymerization method, for example, the visualizing agent, a polymerizable monomer that can form binder resin, and, if necessary, a polymerization initiator, a crosslinking agent, a charge control agent, and other additives, are uniformly dispersed to obtain a polymerizable monomer composition. Thereafter, the obtained polymerizable monomer composition is dispersed with an appropriate stirrer and granulated in a continuous phase (e.g., aqueous phase) containing a dispersion stabilizer, and a polymerization reaction is performed using a polymerization initiator to obtain toner particles with a desired particle diameter.

### (3) Emulsion Aggregation Method

In manufacturing toner using an emulsion aggregation method, initially, the materials such as the visualizing agent, the binder resin, and other additive are dispersed and mixed in a water-based medium containing a dispersion stabilizer. A surfactant may be added to the water-based medium. Thereafter, the mixture is aggregated by adding a coagulant until the desired particle diameter is achieved. Subsequently, or simultaneously with aggregation, the resin particles are fused together. Additionally, if necessary, shape control is performed by heat to form the toner particles. Thereafter, toner particles obtained through a filtration and washing process and a drying process.

Further, as necessary, a process of dispersing the visualizing agent in the binder resin may be included in the series of toner manufacturing processes. Examples of methods for dispersing the binder resin in the visualizing agent include a method in which a masterbatch is used during a toner manufacturing process. Specifically, the visualizing agent is mixed with part of the binder resin to achieve a high concentration of the visualizing agent, and the mixture is melt-kneaded under high shear to produce a masterbatch in which the visualizing agent is finely dispersed. Thereafter, the masterbatch is melt-kneaded while being diluted with the remaining binder resin. Examples of melt-kneading apparatuses suitable for masterbatch manufacturing include a kneader, a Banbury mixer, a two-roll mill, and a three-roll mill, and these apparatuses can be used alone or in combination. Examples of melt-kneading apparatuses suitable for dilution kneading include a twin-screw kneader. Further, as necessary, a process for controlling the aggregation of the visualization agent may be included in the series of toner manufacturing.

Examples of a method for controlling the aggregation of the visualization agent during toner manufacturing include a method in which rapid cooling is performed after the melt-kneading process. For example, rapid cooling of the melt-kneaded material can be achieved by spreading the melt-kneaded material into a sheet form on a metal belt cooled with water. Rapid cooling controls the aggregation of the visualizing agent during cooling. Examples of cooling apparatuses suitable for rapid cooling include “NR double-belt cooler for high viscosity (manufactured by Nippon Belting Co., Ltd.)”, “cooling and solidifying machine belt drum flaker (manufactured by Nippon Coke & Engineering Co., Ltd.)”, and “cooling and solidifying apparatus drum flaker (manufactured by Katsuragi Industry Co., Ltd.)”.

The process of dispersing the visualizing agent in the binder resin and the method for controlling the aggregation of the visualizing agent may be used in combination.

### <Various Additives>

As necessary, the toner may contain one or more types of additives selected from waxes, charge control agents, and external additives. Further, the toner according to the present disclosure desirably does not contain any coloring component that can change a fixed image into a visible image.

### <Wax>

The wax is not particularly limited, but colorless or lightly colored wax is desirable. Examples include hydrocarbon wax, ester wax, amide wax, higher aliphatic alcohols, and higher fatty acids. One type of wax may be used alone, or a plurality of types of wax may be used in combination.

### <Charge Control Agent>

The charge control agent is not particularly limited, but a colorless or lightly colored charge control agent is desirable. Examples include aromatic oxycarboxylic acid, a metal compound of aromatic oxycarboxylic acid, a boron compound, a quaternary ammonium salt, calixarene, a resin including a sulfonic acid (salt) group, and a resin including a sulfonic acid ester group. One type of a charge control agent may be used alone, or a plurality of types of charge control agents may be used in combination.

### <External Additive>

The external additive is not particularly limited, but a colorless or lightly colored external additive is desirable. Examples include silica, alumina, titanium oxide, strontium titanate, silicon nitride, polytetrafluoroethylene, and zinc stearate. Further, the surface of the external additive may be hydrophobically treated.

Further, the average particle diameter of the primary particles of the external additive is desirably 1/10 or less of the weight average particle diameter (D4) of the toner particles.

### <Developer>

Toner can be used as single-component developer and can also be mixed with a carrier to be used as two-component developer. As carriers, for example, magnetic particles made of known materials, such as metals, such as iron, ferrite, and magnetite, alloys of these metals with other metals, such as aluminum or lead, can be used. Further, a coated carrier with its surface covered by a coating agent, such as resin, or a resin-dispersed carrier in which magnetic particles are dispersed in a binder resin can be used. The volume average particle diameter of the carriers is desirably 15 μm or more and 100 μm or less, more desirably 25 μm or more and 80 μm or less.

### Second Embodiment: Disinfectant Visualizing Particle

Disinfectant visualizing particles 303 according to a second embodiment changes the color state upon exposure to the disinfectant. Specifically, a visualizing agent 302 that undergoes a color change upon exposure to the disinfectant and a carrier particle 301 carrying the visualizing agent 302 are included. The disinfectant visualizing particles 303 according to the present embodiment may include a decolorization time control portion. The decolorization time control portion does necessarily have to be layered. As the decolorization time control portion, porous particles can be used. For example, at least one type selected from the group consisting of mesoporous silica particles, porous silica particles, porous titania particles, porous zirconia particles, porous ceria particles, porous zinc oxide particles, porous crosslinked polymethyl methacrylate particles, porous crosslinked polystyrene particles, and porous methyl methacrylate-styrene copolymer crosslinked particles can be used. Disinfectant-visualizing particles with chromogenic portions can be formed by impregnating the porous particles with a solution in which the visualizing agent is dissolved and then drying them.

The surface of the porous particles may be treated to be hydrophilic or hydrophobic treated. In a case where the disinfectant is aqueous, hydrophilicity is desired. In a case where the disinfectant is non-aqueous, hydrophobicity is desired.

Further, the disinfectant visualizing particles are desirable because the disinfectant visualizing particles have high rigidity, making them durable even after repeated wiping with the disinfectant.

The particle diameter of the disinfectant visualizing particle is desirably 30 nm or more and 5 μm or less, more desirably 50 nm or more and 3 μm or less, even more desirably 80 nm or more and 1 μm or less. With a particle diameter of 30 nm or more, the particles are less prone to aggregation. Further, with a particle diameter of 5 μm or less, the disinfectant visualizing particles are less prone to settling when dispersed in a solution.

### <Sheet Using Disinfectant Visualizing Particles>

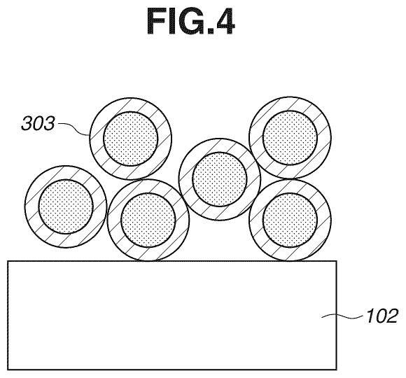

The disinfectant visualizing particles 303 according to the present embodiment may be disposed on the base material 102 as illustrated in FIG. 4 to use the disinfectant visualizing particles 303 as a sheet with disinfectant visualizing particles.

### <Coating Solution of Visualizing Particles and Coated Article>

The disinfectant visualizing particles 303 according to the present embodiment can be used as a coating solution, such as a dispersion or a slurry. The coating solution may be applied to an article to create a coated article.

### <Modified Example of Visualizing Particles>

The disinfectant visualizing particles 303 according to the present embodiment do not necessarily have to be particle-shaped. For example, rod, plate, or film shapes may be used. In the case of a film shape, it is particularly desirable to include a decolorization time control portion to maintain resistance to wiping with the disinfectant.

### Third Embodiment: Disinfectant Visualization Method

An example of a disinfectant visualization method according to a third embodiment includes a process of providing the disinfectant visualizing sheet according to the first embodiment on a surface to be disinfected and a process of applying a disinfectant to the disinfectant visualizing sheet disposed on the surface to be disinfected.

Another disinfectant visualization method according to the present embodiment includes a process of applying the disinfectant visualizing particles according to the second embodiment to a surface to be disinfected and a process of applying a disinfectant to the disinfectant visualizing particles disposed on the surface to be disinfected.

### EXAMPLES

The present invention will be described in more detail below with reference to Examples and Comparative Examples, but it is not limited to the Examples described below, disposed it does not exceed the gist thereof. It should be noted that component amounts indicated by “parts” and “%” are based on mass, unless otherwise specified. The wear resistance test of the Examples was conducted as described below. A load of 100 g was applied to a slider with Silbon paper attached on a surface property tester HEIDON Type:38 (manufactured by Shinto Scientific Co., Ltd.), and a sample was worn for 1 minute at a speed of 50 reciprocations per minute. The wear resistance was evaluated using optical microscope observation and reflectance measurement. The optical microscope observation was performed using an optical microscope (BX51M manufactured by Olympus Corporation).

### <Manufacture of Disinfectant Visualizing Sheet>

### Example 1

As a visualizing agent, 70 ml of ultrapure water, 30 ml of ethylene glycol, and 0.1 g of surfactant (product name: OLFINE PD-005, manufactured by Nissin Chemical Industry Co., Ltd.) were added to 0.5 g of Phenolphthalein (manufactured by Tokyo Chemical Industry Co., Ltd.) to obtain a composition. The composition was filled into an ink cartridge, and the ink cartridge was set in an inkjet recording apparatus (PIXUS iP7230 manufactured by Canon Inc.) configured to eject ink from a recording head using thermal energy. In the present example, a solid image recorded by applying eight droplets of ink per 1/600 inch× 1/600 inch unit area, with each drop being 2.5 pL, is defined as “having a recording duty of 100%”. Using this inkjet recording apparatus, a solid image with a recording duty of 100% was recorded in an environment with a temperature of 23° C. and a relative humidity of 55%. Glossy paper (Product name: Glossy Pro PT-201, manufactured by Canon Inc.) was used as the substrate. The obtained recorded material was dried for 24 hours in an environment with a temperature of 23° C. and a relative humidity of 55% to obtain a print (shape: rectangular image of 2 mm×3 cm.

A coating portion was formed on the print as described below. 10 g of ethanol (manufactured by Kishida Chemical Co., Ltd.) was added to 10 g of 3-aminopropyltrimethoxysilane (manufactured by Tokyo Chemical Industry Co., Ltd.). This solution was applied using a Baker-type applicator (manufactured by Tester Sangyo Co,. Ltd.) so that the thickness h when dried was 150 nm. Then, it was placed on a hot plate heated to 50° C. and dried for 30 minutes. This will be referred to as sheet 1.

### Examples 2 to 48

Disinfectant visualizing sheets (sheets 2 to 50) were manufactured similarly, except that the thickness h of the visualizing agent and the decolorization time control portion was changed as presented in Table 1. These will be referred to as Examples 2 to 50.

### Comparative Example 1

A sample without the coating portion of Example 12 was used as Comparative Example 1.

### Example 49

Visualizing agent: O-Cresol Phthalein: 2.0 parts

Dispersing agent: dispersing agent Disper BKY 190 manufactured by BYK-Chemie
GmbH: 0.8 parts
Ion-exchanged water: 16 parts

These were dispersed (a planetary ball mill manufactured by Fritsch J apan Co., Ltd, 300 rpm, 4 hours, medium: zirconia beads, diameter 0.5 mm, media fill ratio 70%), diluted with a 15% glycerin aqueous solution to achieve a 5% visualizing agent concentration relative to the total mass of the marking composition, stirred with a stirrer for 1 hour, and then filtered through a 0.5-μ filter to obtain the marking composition for the visualizing agent.

The rest of the process was performed as in Example 1 to manufacture a disinfection visualization sheet 49. This will be referred to as Example 49.

### Example 50

Visualizing agent: Thymolphthalein: 2.0 parts

Dispersing agent: dispersing agent Disper BKY 190 manufactured by BYK-Chemie
GmbH: 2.0 parts
Ion-exchanged water: 16 parts

These were dispersed (a planetary ball mill manufactured by Fritsch J apan Co., Ltd, 300 rpm, 4 hours, medium: zirconia beads, diameter 0.5 mm, media fill ratio 70%), diluted with a 15% glycerin aqueous solution to achieve a 5% visualizing agent concentration relative to the total mass of the marking composition, stirred with a stirrer for 1 hour, and then filtered through a 0.5-μ filter to obtain the marking composition for the visualizing agent.

The rest of the process was performed as in Example 1 to manufacture a disinfection visualization sheet 50. This will be referred to as Example 50.

TABLE 1

| | Disinfection | | | | | Coating |
|---|---|---|---|---|---|---|
| | Visualization | Coloring | Base | Coating | Coating | Portion |
| Example | Sheet | Agent | Material | Portion 1 | Portion 2 | Thickness |
| Example 1 | Sheet 1 | Phenolphthalein | Glossy | Amino | | 150 |
| | | | Paper | | | |
| Example 2 | Sheet 2 | Phenolphthalein | Glossy | Vinyl | | 150 |
| | | | Paper | | | |
| Example 3 | Sheet 3 | Phenolphthalein | Glossy | Epoxy | | 150 |
| | | | Paper | | | |
| Example 4 | Sheet 4 | Phenolphthalein | Glossy | Methacryl | | 150 |
| | | | Paper | | | |
| Example 5 | Sheet 5 | Phenolphthalein | Glossy | Acryl | | 150 |
| | | | Paper | | | |
| Example 6 | Sheet 6 | Phenolphthalein | Glossy | Styryl | | 150 |
| | | | Paper | | | |
| Example 7 | Sheet 7 | Phenolphthalein | Glossy | Isocyanurate | | 150 |
| | | | Paper | | | |
| Example 8 | Sheet 8 | Phenolphthalein | Glossy | Ureido | | 150 |
| | | | Paper | | | |
| Example 9 | Sheet 9 | Phenolphthalein | Glossy | Mercapto | | 150 |
| | | | Paper | | | |
| Example 10 | Sheet 10 | Phenolphthalein | Glossy | Isocyanate | | 150 |
| | | | Paper | | | |
| Example 11 | Sheet 11 | Phenolphthalein | Glossy | Polyethyleneimine | | 150 |
| | | | Paper | | | |
| Example 12 | Sheet 12 | o-Cresolphthalein | Glossy | Amino | | 150 |
| | | | Paper | | | |
| Example 13 | Sheet 13 | o-Cresolphthalein | Glossy | Amino2 | | 150 |
| | | | Paper | | | |
| Example 14 | Sheet 14 | o-Cresolphthalein | Glossy | Vinyl | | 150 |
| | | | Paper | | | |
| Example 15 | Sheet 15 | o-Cresolphthalein | Glossy | Epoxy | | 150 |
| | | | Paper | | | |
| Example 16 | Sheet 16 | o-Cresolphthalein | Glossy | Methacryl | | 150 |
| | | | Paper | | | |
| Example 17 | Sheet 17 | o-Cresolphthalein | Glossy | Acryl | | 150 |
| | | | Paper | | | |
| Example 18 | Sheet 18 | o-Cresolphthalein | Glossy | Styryl | | 150 |
| | | | Paper | | | |
| Example 19 | Sheet 19 | o-Cresolphthalein | Glossy | Isocyanurate | | 150 |
| | | | Paper | | | |
| Example 20 | Sheet 20 | o-Cresolphthalein | Glossy | Ureido | | 150 |
| | | | Paper | | | |
| Example 21 | Sheet 21 | o-Cresolphthalein | Glossy | Mercapto | | 150 |
| | | | Paper | | | |
| Example 22 | Sheet 22 | o-Cresolphthalein | Glossy | Isocyanate | | 150 |
| | | | Paper | | | |
| Example 23 | Sheet 23 | o-Cresolphthalein | Glossy | Polyethyleneimine | | 150 |
| | | | Paper | | | |
| Example 24 | Sheet 24 | Thymolphthalein | Glossy | Amino | | 150 |
| | | | Paper | | | |
| Example 25 | Sheet 25 | Thymolphthalein | Glossy | Amino2 | | 150 |
| | | | Paper | | | |
| Example 26 | Sheet 26 | Thymolphthalein | Glossy | Vinyl | | 150 |
| | | | Paper | | | |
| Example 27 | Sheet 27 | Thymolphthalein | Glossy | Epoxy | | 150 |
| | | | Paper | | | |
| Example 28 | Sheet 28 | Thymolphthalein | Glossy | Methacryl | | 150 |
| | | | Paper | | | |
| Example 29 | Sheet 29 | Thymolphthalein | Glossy | Acryl | | 150 |
| | | | Paper | | | |
| Example 30 | Sheet 30 | Thymolphthalein | Glossy | Styryl | | 150 |
| | | | Paper | | | |
| Example 31 | Sheet 31 | Phenolphthalein | OHP Sheet | Amino | | 150 |
| Example 32 | Sheet 32 | Phenolphthalein | OHP Sheet | Methacryl | | 150 |
| Example 33 | Sheet 33 | o-Cresolphthalein | OHP Sheet | Amino | | 150 |
| Example 34 | Sheet 34 | o-Cresolphthalein | OHP Sheet | Vinyl | | 150 |
| Example 35 | Sheet 35 | Thymolphthalein | OHP Sheet | Amino | | 150 |
| Example 36 | Sheet 36 | Thymolphthalein | OHP Sheet | Styryl | | 150 |
| Example 37 | Sheet 37 | Phenolphthalein | Glossy | Vinyl | | 20 |
| | | | Paper | | | |
| Example 38 | Sheet 38 | Phenolphthalein | Glossy | Vinyl | | 100 |
| | | | Paper | | | |
| Example 39 | Sheet 39 | Phenolphthalein | Glossy | Vinyl | | 250 |
| | | | Paper | | | |
| Example 40 | Sheet 40 | o-Cresolphthalein | Glossy | Amino | | 20 |
| | | | Paper | | | |
| Example 41 | Sheet 41 | o-Cresolphthalein | Glossy | Amino | | 100 |
| | | | Paper | | | |
| Example 42 | Sheet 42 | o-Cresolphthalein | Glossy | Amino | | 250 |
| | | | Paper | | | |
| Example 43 | Sheet 43 | o-Cresolphthalein | Glossy | Amino | Vinyl | 250 |
| | | | Paper | | | |
| Example 44 | Sheet 44 | o-Cresolphthalein | Glossy | Amino | Methacryl | 250 |
| | | | Paper | | | |
| Example 45 | Sheet 45 | o-Cresolphthalein | Glossy | Amino2 | Styryl | 250 |
| | | | Paper | | | |
| Example 46 | Sheet 46 | Thymolphthalein | Glossy | Amino | Vinyl | 250 |
| | | | Paper | | | |
| Example 47 | Sheet 47 | Thymolphthalein | Glossy | Amino | Methacryl | 250 |
| | | | Paper | | | |
| Example 48 | Sheet 48 | Thymolphthalein | Glossy | Amino2 | Styryl | 250 |
| | | | Paper | | | |
| Example 49 | Sheet 49 | o-Cresolphthalein | Glossy | Amino | | 150 |
| | | dispersion | Paper | | | |
| Example 50 | Sheet 50 | Thymolphthalein | Glossy | Amino | | 150 |
| | | dispersion | Paper | | | |
| Comparative | Sheet 51 | o-Cresolphthalein | Glossy | None | | 0 |
| Example 1 | | | Paper | | | |

In Table 1, Amino refers to 3-aminopropyltrimethoxysilane, Amino2 refers to N-2-(aminoethyl)-3-aminopropyltrimethoxysilane, Vinyl refers to vinyltrimethoxysilane, Epoxy refers to 3-glycidoxypropyltrimethoxysilane, methacryl refers to 3-methacryloxypropyltrimethoxysilane, acryl refers to 3-acryloxypropyltrimethoxysilane, styryl refers to p-styryltrimethoxysilane, isocyanurate refers to tris-(trimethoxysilylpropyl)isocyanurate, ureido refers to 3-ureidopropyltrialkoxysilane, mercapto refers to 3-mercaptopropyltrimethoxysilane, and isocyanate refers to 3-isocyanatepropyltrimethoxysilane.

### Examples 51 to 100

### Comparative Example 2

### <Evaluation>

### <Evaluation (Color Change)>

A 0.5 wt % sodium hypochlorite aqueous solution and an 80% ethanol aqueous solution were used as disinfectants. One milliliter of disinfectant was dropped onto a Kimwipe (a brand of disposable paper wipes), and the disinfectant was applied to the disinfectant visualizing sheet using the Kimwipe. The sheet was placed on white paper and imaged on video. The imaged video was converted to grayscale from 0 to 255, and the absolute values of amounts of change in values before and after the application were measured. Among the following evaluation criteria, “A” and “B” were set to acceptable levels, while “C” was set as an unacceptable level.
A: 30 or more
B: 15 or more and less than 30
C: Less than 15

### <Evaluation (Durability)>

Regarding wear resistance, those without noticeable wear marks observed under optical microscopy after the wear test and with no significant changes in reflectance in the visible and infrared regions before and after the wear test were classified as A. Further, those with a noticeable wear mark observed under optical microscopy after the wear test or with a significant change in reflectance in the visible and infrared regions before and after the wear test were classified as B. Among the following evaluation criteria, “A” was set as an acceptable level, while “B” was set as an unacceptable level.
A: Small changes in reflectance, no wear marks
B: Large changes in reflectance, with a wear mark
   The results are presented in Table 2.

TABLE 2

| | | | Evaluation | | Evaluation |
|---|---|---|---|---|---|
| | Visualization | | (color | Evaluation | (color |
| Example | Sheet | Disinfectant | change) | (durability) | change) |
| Example 51 | Sheet 1 | Ethanol Aqueous Solution | A | A | 51 |
| Example 52 | Sheet 2 | Sodium Hypochlorite Aqueous Solution | A | A | 49 |
| Example 53 | Sheet 3 | Sodium Hypochlorite Aqueous Solution | A | A | 38 |
| Example 54 | Sheet 4 | Sodium Hypochlorite Aqueous Solution | A | A | 48 |
| Example 55 | Sheet 5 | Sodium Hypochlorite Aqueous Solution | A | A | 40 |
| Example 56 | Sheet 6 | Sodium Hypochlorite Aqueous Solution | A | A | 42 |
| Example 57 | Sheet 7 | Sodium Hypochlorite Aqueous Solution | A | A | 45 |
| Example 58 | Sheet 8 | Sodium Hypochlorite Aqueous Solution | A | A | 45 |
| Example 59 | Sheet 9 | Sodium Hypochlorite Aqueous Solution | A | A | 41 |
| Example 60 | Sheet 10 | Sodium Hypochlorite Aqueous Solution | A | A | 42 |
| Example 61 | Sheet 11 | Ethanol Aqueous Solution | A | A | 39 |
| Example 62 | Sheet 12 | Ethanol Aqueous Solution | A | A | 52 |
| Example 63 | Sheet 13 | Ethanol Aqueous Solution | A | A | 44 |
| Example 64 | Sheet 14 | Sodium Hypochlorite Aqueous Solution | A | A | 51 |
| Example 65 | Sheet 15 | Sodium Hypochlorite Aqueous Solution | A | A | 41 |
| Example 66 | Sheet 16 | Sodium Hypochlorite Aqueous Solution | A | A | 34 |
| Example 67 | Sheet 17 | Sodium Hypochlorite Aqueous Solution | A | A | 42 |
| Example 68 | Sheet 18 | Sodium Hypochlorite Aqueous Solution | A | A | 44 |
| Example 69 | Sheet 19 | Sodium Hypochlorite Aqueous Solution | A | A | 38 |
| Example 70 | Sheet 20 | Sodium Hypochlorite Aqueous Solution | A | A | 40 |
| Example 71 | Sheet 21 | Sodium Hypochlorite Aqueous Solution | A | A | 40 |
| Example 72 | Sheet 22 | Sodium Hypochlorite Aqueous Solution | A | A | 35 |
| Example 73 | Sheet 23 | Ethanol Aqueous Solution | A | A | 31 |
| Example 74 | Sheet 24 | Ethanol Aqueous Solution | B | A | 26 |
| Example 75 | Sheet 25 | Ethanol Aqueous Solution | B | A | 29 |
| Example 76 | Sheet 26 | Sodium Hypochlorite Aqueous Solution | B | A | 22 |
| Example 77 | Sheet 27 | Sodium Hypochlorite Aqueous Solution | B | A | 18 |
| Example 78 | Sheet 28 | Sodium Hypochlorite Aqueous Solution | B | A | 24 |
| Example 79 | Sheet 29 | Sodium Hypochlorite Aqueous Solution | B | A | 19 |
| Example 80 | Sheet 30 | Sodium Hypochlorite Aqueous Solution | B | A | 21 |
| Example 81 | Sheet 31 | Ethanol Aqueous Solution | A | A | 44 |
| Example 82 | Sheet 32 | Sodium Hypochlorite Aqueous Solution | A | A | 41 |
| Example 83 | Sheet 33 | Ethanol Aqueous Solution | A | A | 45 |
| Example 84 | Sheet 34 | Sodium Hypochlorite Aqueous Solution | A | A | 48 |
| Example 85 | Sheet 35 | Ethanol Aqueous Solution | B | A | 24 |
| Example 86 | Sheet 36 | Sodium Hypochlorite Aqueous Solution | B | A | 25 |
| Example 87 | Sheet 37 | Sodium Hypochlorite Aqueous Solution | A | A | 45 |
| Example 88 | Sheet 38 | Sodium Hypochlorite Aqueous Solution | A | A | 46 |
| Example 89 | Sheet 39 | Sodium Hypochlorite Aqueous Solution | A | A | 40 |
| Example 90 | Sheet 40 | Ethanol Aqueous Solution | A | A | 42 |
| Example 91 | Sheet 41 | Ethanol Aqueous Solution | A | A | 41 |
| Example 92 | Sheet 42 | Ethanol Aqueous Solution | A | A | 40 |
| Example 93 | Sheet 43 | Ethanol Aqueous Solution | A | A | 40 |
| Example 94 | Sheet 44 | Ethanol Aqueous Solution | A | A | 39 |
| Example 95 | Sheet 45 | Ethanol Aqueous Solution | A | A | 44 |
| Example 96 | Sheet 46 | Ethanol Aqueous Solution | B | A | 18 |
| Example 97 | Sheet 47 | Ethanol Aqueous Solution | B | A | 22 |
| Example 98 | Sheet 48 | Ethanol Aqueous Solution | B | A | 26 |
| Example 99 | Sheet 49 | Ethanol Aqueous Solution | A | A | 45 |
| Example 100 | Sheet 50 | Ethanol Aqueous Solution | A | A | 45 |
| Comparative | Sheet 51 | Sodium Hypochlorite Aqueous Solution | A | B | 45 |
| Example 2 | | | | | |

When a wear test was conducted on Comparative Example 2, a noticeable wear mark was observed. Further, a significant change in reflectance in the visible and infrared regions was observed before and after the wear test.

The foregoing disclosure includes the following configurations.

### (Configuration 1)

A disinfectant visualizing sheet comprising a base material, a chromogenic portion disposed on the base material, and a coating portion on the chromogenic portion, wherein the chromogenic portion includes a visualizing agent that changes a color state thereof upon exposure to a disinfectant, and wherein the coating portion has a silsesquioxane structure.

### (Configuration 2)

The disinfectant visualizing sheet according to Configuration 1, wherein the coating portion has a thickness of 10 nm or more and 300 nm or less.

### (Configuration 3)

The disinfectant visualizing sheet according to Configuration 1 or 2, wherein the coating portion has the silsesquioxane structure containing at least one type of functional group selected from the group consisting of vinyl group, epoxy group, amino group, styryl group, methacrylic group, acrylic group, isocyanurate group, ureido group, mercapto group, and isocyanate group.

### (Configuration 4)

A disinfectant visualizing sheet comprising a base material, a chromogenic portion disposed on the base material, and a coating portion on the chromogenic portion, wherein the chromogenic portion includes a visualizing agent that changes a color state thereof upon exposure to a disinfectant, and wherein the coating portion includes polyethyleneimine.

The present invention is not limited to the embodiments described above, and various changes and modifications are possible without departing from the spirit and scope of the present invention. Accordingly, the following claims are appended to publicly disclose the scope of the present invention.

The disinfectant visualizing sheet and the disinfectant visualizing particle according to the present invention can be stored for a long time, can allow convenient visual confirmation of an application of a disinfectant, and can be used repeatedly.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A disinfectant visualizing sheet, comprising a base material, a chromogenic portion disposed on the base material, and a coating portion on the chromogenic portion,
wherein the chromogenic portion includes a visualizing agent that changes a color state thereof upon exposure to a disinfectant, and
wherein the coating portion has a silsesquioxane structure.

2. The disinfectant visualizing sheet according to claim 1, wherein the coating portion has a thickness of 10 nm or more and 300 nm or less.

3. The disinfectant visualizing sheet according to claim 1, wherein the coating portion has the silsesquioxane structure containing at least one type of functional group selected from the group consisting of vinyl group, epoxy group, amino group, styryl group, methacrylic group, acrylic group, isocyanurate group, ureido group, mercapto group, and isocyanate group.

4. A disinfectant visualizing sheet, comprising a base material, a chromogenic portion disposed on the base material, and a coating portion on the chromogenic portion,
wherein the chromogenic portion includes a visualizing agent that changes a color state thereof upon exposure to a disinfectant, and
wherein the coating portion includes polyethyleneimine.
